(19) United States
(12) Patent Application Publication
(10) Pub. No.: US 2007/0116525 A1
(43) Pub. Date: May 24, 2007

(54) Landfill including highly permeable

(75) Inventors: Gary R. Hater, Cincinnati, OH (US); Roger B. Green, Cincinnati, OH (US); Jeffrey M. Harris, Cypress, TX (US); Phillip A. Smith, Spring, TX (US); Greg A. Enterline, Williamsburg, VA (US); Michael Thomas, Montpelier, VA (US); Kevin Mieczkowski, Goshen, KY (US); John A. Barbush, Goshen, KY (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waste Management, Inc.

(21) Appl. No.: 11/287,045

(22) Filed: Nov. 22, 2005

(51) Int. Cl. B09B 5/00

(52) U.S. Cl. 405/129.95

(57) ABSTRACT

A landfill and method for constructing a landfill including a plurality of waste layers, each waste layer separated by highly permeable material layer and at least one vertical gas extraction well having a perforated casing the penetrates at least one of the highly permeable material layers.

### BACKGROUND OF THE INVENTION

(1) Field of the Invention

This invention concerns landfills including permeable zones comprising one or more vertically separated highly permeable material layers and at least one gas extraction well that penetrates and withdraws landfill gases from the at least one highly permeable material layer.

(2) Description of the Art

Landfills that are filled with compostable waste materials, such as municipal solid waste materials, commonly include vertical gas extraction wells. The vertical gas extraction wells provide for the controlled removal of landfill decomposition by-product gases including methane from landfills thereby reducing landfill odor and accelerating landfill decomposition.

A standard landfill typically includes a plurality of vertical gas extraction wells typically separated by 100 to 200 feet or more. The vertical gas extraction wells are generally placed in a landfill cell after the cell filled with waste material by excavating a bore hole approximately 3 feet in diameter in the landfill cell, locating a casing in the excavated borehole and filling the annulus between the casing the bore hole with a porous media such as gravel.

Landfill gas extraction methods and structures are well known in the art. U.S. Pat. No. 4,798,801 discloses methods for producing methane from the anaerobic fermentation of waste materials such as municipal solid waste. U.S. Pat. No. 5,857,807 discloses landfill cells including a methane gas containment layer. The disclosed landfill cells include leachate collection pipes and gas extraction wells for removing methane and other gases from the cells. U.S. Pat. Nos. 6,505,681 and 6,338,386 disclose methods for improving methane gas recovery from landfills by forming fissures in the municipal solid waste placed in a landfill using carbon dioxide gas pressurization techniques.

Despite improvements made to landfill gas recovery methods and apparatuses, there remains a need for methods and for landfills in which landfil gases, including methane, can be recovered more efficiently from a larger landfill areas with fewer gas extraction wells.

### SUMMARY OF THE INVENTION

One aspect of this invention are methods for constructing a landfill waste disposal cells comprising the steps of: placing a first layer of waste material in a landfill wherein the waste material includes an exposed surface; placing a first highly permeable material layer on top of the first layer of waste material such that the first highly permeable material layer at least partially covers the exposed surface of the first waste material layer; placing a second layer of waste material on the first highly permeable material layer; and installing a gas extraction well including a perforated casing in the landfill cell such that the casing passes through the first horizontal highly permeable material layer.

Another aspect of this invention includes methods for constructing a permeable zone in a landfill comprising the steps of: placing a first layer of waste material in a landfill wherein the waste material includes an exposed surface; placing a first highly permeable material layer on top of the first layer of waste material such that the first highly permeable material layer at least partially covers the exposed surface of the first waste material layer; placing a second layer of waste material on the first highly permeable material layer wherein the second layer of waste material has an exposed surface; placing a second highly permeable material layer on top of the second layer of waste material such that the second highly permeable material layer at least partially covers the exposed surface of the second waste material layer, the combination of the first highly permeable layer and second highly permeable layer defining a permeable zone; and placing a third layer of waste material on top of the second highly permeable material layer.

Still another aspect of this invention are one or more permeable zones located in a landfill comprising: a plurality of highly permeable layers, each highly permeable layer separated from one another wherein a waste material layer is located between at least two adjacent highly permeable layers; and a gas extraction well including a casing having a first end located in the landfill a second end located outside of the landfill and a perforated portion located between the casing first end and second end wherein the casing passes through at least one of the highly permeable material layers such that casing perforations are located in the highly permeable material layer.

### DESCRIPTION OF THE FIGURES

FIG. 1 is an overhead schematic of a landfill waste disposal cell embodiment of this invention including a plurality of vertically separated horizontal highly porous material layers;

FIGS. 2A and 2B are elevation views of a landfill waste disposal cell embodiment of this invention depicting the placement of a plurality of vertically separated horizontal highly porous material layers;

FIG. 3 is an elevation view of a landfill waste disposal cell embodiment of this invention including a plurality of horizontal highly porous material layers located at vertical intervals that are slightly offset from non-contiguous or stripped horizontal daily cover layers;

FIG. 4 is an elevation view of a landfill waste disposal cell embodiment of this invention including a plurality of horizontal highly porous material layers located at vertical intervals that are offset from contiguous horizontal daily cover layers;

FIG. 5 is a landfill waste disposal cell embodiment of this invention including a plurality of vertically separated horizontal highly porous material layers wherein several of the horizontal highly porous material layers encroach upon the landfill cell slope; and

FIGS. 6A and 6B are aspects of an expemplary gas collection well useful in the landfill waste disposal cells and methods of this invention.

### DESCRIPTION OF THE CURRENT EMBODIMENT

The present invention relates to landfill waste disposal cells and to methods for constructing landfill waste disposal cells having a highly permeable zone comprising one or more horizontal highly permeable material layers and further including at least one vertical gas extraction well located in the landfill cell such that the at least one vertical gas extraction well penetrates one or more of the plurality of highly permeable material layers. This invention also relates to permeable zones comprising two or more highly permeable material layers associated with at least one landfill gas extraction well and to landfills and landfill cells including one or more permeable zones.

The methods and landfill waste disposal cells of this invention allow for the progressive installation of vertical landfill gas collection wells during the construction of a landfill waste disposal cell. In one embodiment, the methods of this invention are accomplished by placing one or more layers of highly permeable material one on top of the other at different vertical locations in the waste disposal cell as it is being filled with municipal solid waste. The layers of highly permeable material provide a preferential flow path (or “path of least resistance”) for landfill gases and liquids to flow from the landfill into one or more gas extraction wells. The locations of the highly permeable material layers are recorded as they are installed using standard surveying practices or using GPS techniques. Once the construction of a landfill waste disposal cell is complete, the approximate center of each permeable zone comprising one or more highly permeable layers is located using, for example GPS or traditional surveying methods, and a conventional vertical gas extraction well is placed in each of the approximate centers of each permeable zone.

The methods and waste disposal cells of this invention allow for increased gas yield and drainage in a defined landfill cell area by providing a preferential flow path for liquids and for landfill gases. Moreover, the methods of this invention involve landfill construction techniques that are familiar to landfill contractors.

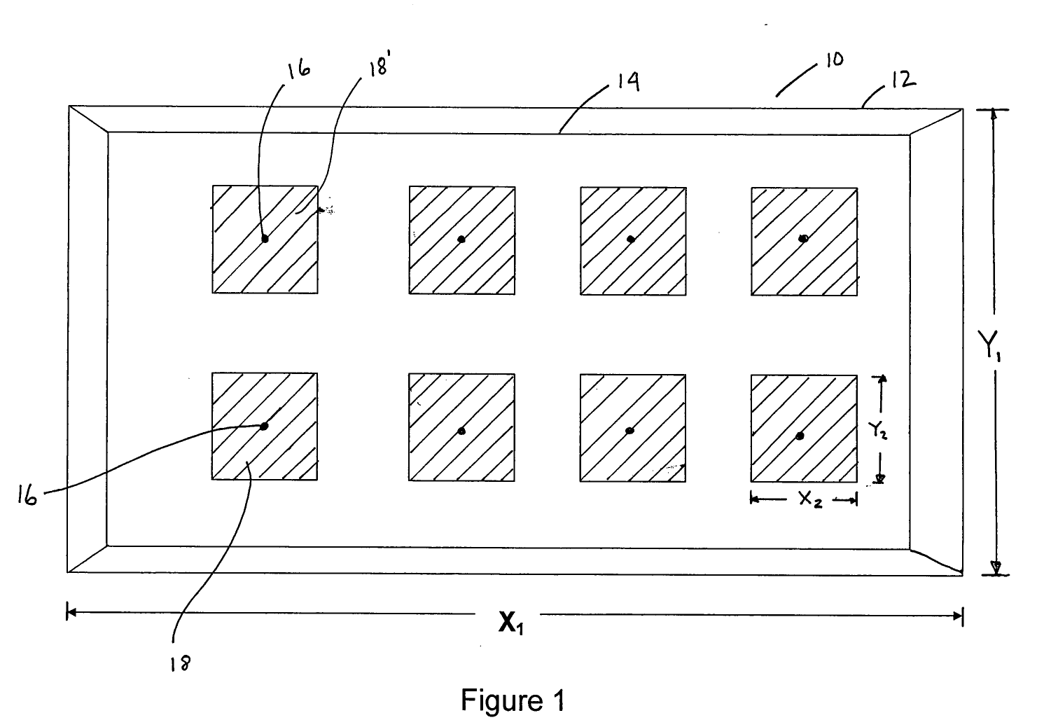

FIG. 1 is an overhead view of a landfill waste disposal cell 10 embodiment of this invention. Landfill waste disposal cell 10 includes a boundary 12 defining the periphery of landfill waste disposal cell 10. Landfill waste disposal cell 10 further includes a plurality of highly permeable zones 18 located at defined or undefined intervals throughout the cell. Each highly permeable zone 18 further includes at least one landfill gas extraction well 16 preferably placed in approximately the center of each highly permeable zone 18. However, landfill gas extraction wells 16 are still effective so long as they contact any portion of highly permeable material associated with highly permeable zone 18.

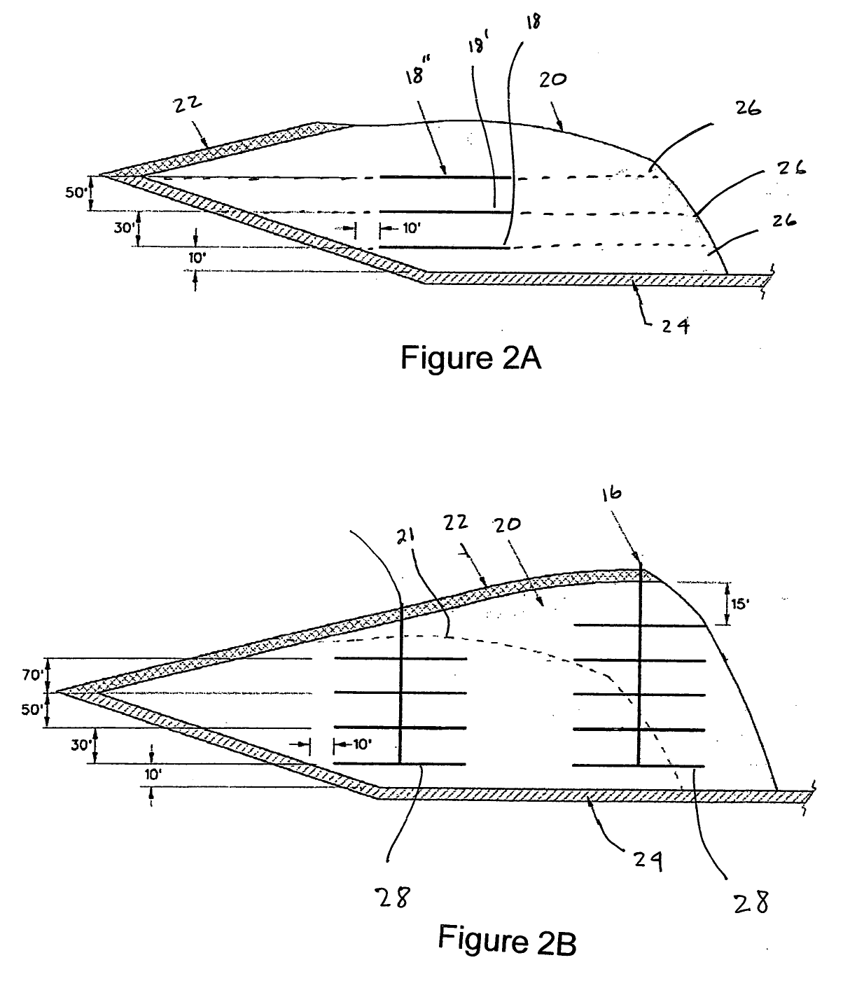

As will become apparent from subsequent Figures, each highly permeable zone 18 will include at least one and preferably a plurality of highly permeable material layers 28. Each highly permeable material layer 28 is separated from one another by a layer of material and preferably a layer of compostable waste material. For example highly permeable zone 18′ of FIG. 2A will generally consist of two or more vertically separated highly permeable material layers 28.

The horizontal area of a landfill waste disposal cell 10 (X₁×Y₁) is not critical. The larger the landfill cell boundary 12, the larger the number of highly permeable zones 18 that may be located in landfill waste disposal cell 10. In general, landfill waste disposal cell will have an Y₁ dimension of approximately 200 to 1000 feet or more and an X₁ dimension of from about 400 to 2000 feet or more. Highly permeable zones 18 may have a variable area (X₂×Y₂) depending upon many factors including the dimensions of landfill cell boundary 12. However, it is preferred that highly permeable zones 18 have a length X₂ of from about 10 to 200 feet or more and a width Y₂ of from 10 to 200 feet or more. In a more preferred aspect, highly permeable zones will have a length X₂ ranging from about 50 to 100 feet or more and a width Y₂ ranging from about 50 to 100 feet or more.

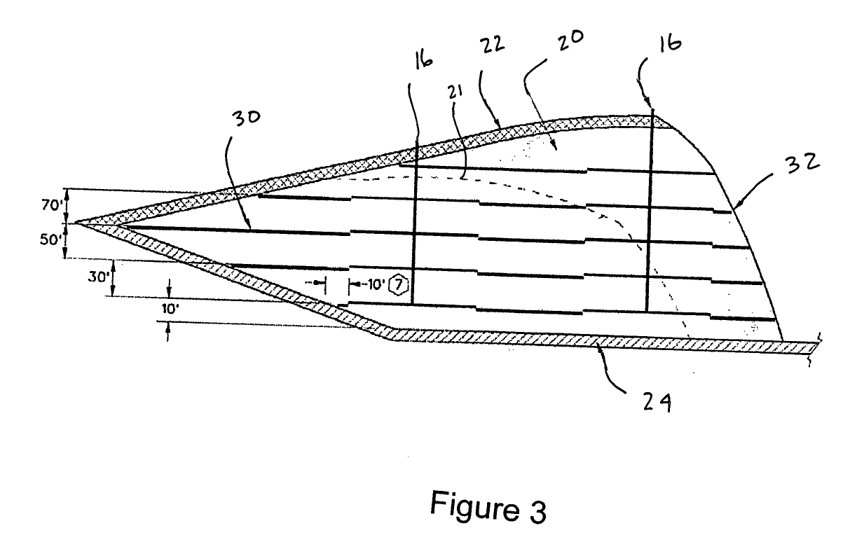

FIGS. 2A and 2B are elevation views of a landfill waste disposal cell embodiment of this invention including a plurality of highly permeable zones 18 each having a plurality of horizontal highly porous material layers 28. The landfill waste disposal cell 10 of FIG. 2A is partially completed. The landfill waste disposal cell 10 of FIG. 2B is a completed landfill waste disposal cell. Landfill waste disposal cell 10 may be constructed for example by placing a liner system 24 at the bottom of landfill waste disposal cell 10. Next, landfill waste disposal cell 10 is filled with waste materials in layers 26. Waste material layers 26 consists of a volume of waste material that may be defined by any known method. The volume may, for example, be the amount of waste material added to a particular area of the landfill waste disposal cell over a period of time such as a day, a week or any other period of time. Alternatively, waste material layer 26 may be an amount of waste material having a particular depth before or after compaction. In yet another alternative, a waste material layer 26 may be defined by the depth of waste material located between highly permeable material layers 28 and/or between highly permeable material layers 28 and the top or bottom of a landfill cell. For example, in FIG. 2A, waste material layers 26 have a depth of from 10 to 50 feet or more depending upon their vertical placement in landfill waste disposal cell 10. One highly permeable material layer 28 will typically be located or adjacent to each waste material layer 26. In FIG. 2A, highly permeable material layers 28 are located at the interface between landfill layers 26. As will be shown in FIGS. 3-5 below, the location of highly permeable material layers 28 in relationship to waste material layers 26 may vary.

FIG. 2B is a side view of a completed landfill waste disposal cell 10. Landfill waste disposal cell 10 of FIG. 2B includes two permeable zones 18, each including a plurality of vertically separated highly permeable material layers 28. A vertical landfill gas extraction well 16 is located in the central portion of each permeable zone 18. A partial final cap 22 covers the waste material 20 located in landfill waste disposal cell 10.

The geometry of the horizontal highly permeable material layers 28 is not critical. Highly permeable material layers 28 may be square, they may be round, they may be oval or they may be amorphous in shape. Moreover, it is not critical that the plurality of highly permeable material layer 28 are located precisely one over the other. Nor is it critical that each of the highly permeable material layers 28 in a single permeable zone 18 all has the same geometry. Instead, highly permeable material layers 28 in a single permeable zone 18 may have different geometries or they may be offset from one another depending upon many factors including the contours of the landfill cell and the composition of the waste material in the cell. However, placing highly permeable material layers 28 in the same permeable zone 18 one over the other and constructing the plurality of highly permeable material layers 28 in a single permeable zone 18 to have essentially the same dimensions and shape allows for the placement of a single vertical gas extraction well 16 in the approximate center of permeable zone 18 where it is able to most efficiently and effectively withdraw landfill gases from the section of landfill waste disposal cell 10 associated with the permeable zone 18.

Generally each highly permeable material layer 28 may have an area ranging from about 100 to 10,000 square feet or more. More preferably, each highly permeable material layer 28 will have an area ranging from about 2500 to 10,000 square feet or more. This corresponds to a square having a dimension for example of from about 10 feet by 15 feet to about 100 feet by 100 feet.

Highly permeable material layer 28 will consist of a highly porous or permeable material. Any material reasonably permeable to gas may be used to form highly permeable material layer 28. Examples of useful reasonably gas permeable materials include, but are not limited to sand, crushed stone, construction and demolition debris, rubber tire chips, auto fluff, plastic bottles, wood debris, geotextiles, geo-et with drain layer, glass cullet and combinations of these materials. If a compressible material such as tire chips or shreds are used, then the tire chips may preferably have a nominal size of 4 inches to 6 inches or more. Useful non-compressible materials such as stone may generally have a nominal diameter size of from 1 to 4 inches or more. Highly permeable material layers 28 are constructed or compressed and/or non-compressible materials may have a thickness ranging from about 1 inch to about 18 inches or more. With the preferred thickness ranging from about 2 to about 8 inches. If a geotextile is used as highly permeable material layer 28, then the geotextile composite drain net thickness can range from ⅜″ to 2″ or more.

FIG. 3 is a side elevation view of a landfill cell embodiment of this invention including a plurality of highly permeable material layers 28 located adjacent to the cover layer 30. Daily cover material layer 30 is generally less permeable than the permeable layer material. Daily cover material layer 30 will typically consist of soil, sand, sludge or other similar material that is used to cover the waste material added to a landfill in a single day in order to keep the materials from blowing away and in order to inhibit the emission of odors from the landfill. Daily cover material layer 30 in FIG. 3 is non-contiguous. That is, daily cover material layer 30 does not cover the entire layer of waste material upon which it is placed. Instead, the daily cover layer 30 is non-contiguous in the area occupied by one or more highly permeable material layers 28. When daily cover layer is non-contiguous, gases in waste material layers 26 located above and below the non-contiguous daily cover layer may be removed from the landfill via a single permeable zone 28 located in the non-contiguous portions of daily cover layer 30. Daily cover layer 30 may be applied in a non-contiguous manner along with the highly permeable material layer 28 to form a complete layer over landfill waste material. Alternatively, daily cover layer may be uniformly applied to landfill waste material and thereafter a portion of the daily cover material layer may be removed to form a non-contiguous portion in which to install a highly permeable material layer 28.

In many jurisdictions, daily cover material cannot be removed from a landfill cell. In such landfills, highly porous material layers 28 may be placed anywhere in landfill including between two daily cover layers 30. In such landfills it is preferred that highly porous material layers 28 are placed at a distance and more preferably about equal distance between daily cover material layers 30 so that gases generated in the waste material located between two daily cover layers 30 can be efficiently removed via highly permeable material layer 28 using landfill by gas extraction well 16.

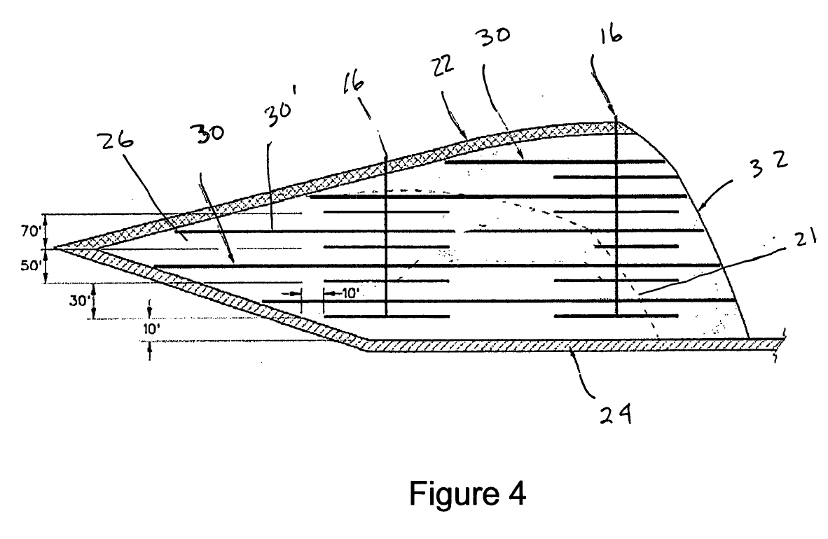

In FIG. 4, the plurality of highly permeable material layers 28 lie essentially in between daily cover layers 30. In addition, daily cover layers 30 are contiguous. In the embodiment shown in FIG. 4, each highly permeable material layer 28 is able to draw landfill gases from waste layer 26 defined as the waste material located between two daily cover layers 30 and 30′.

The landfill cells 10 of FIGS. 2B, 3, 4 and 5 include a temporary intermediate grade 21. When the cell goes to final grade, temporary grade 21 is often left behind (as indicated by the dash lines). When a highly permeable material layer protrudes through intermediate grade 21, drainage and gas collection is improved. The same applies for temporary haul roads erected on partially completed landfill cells.

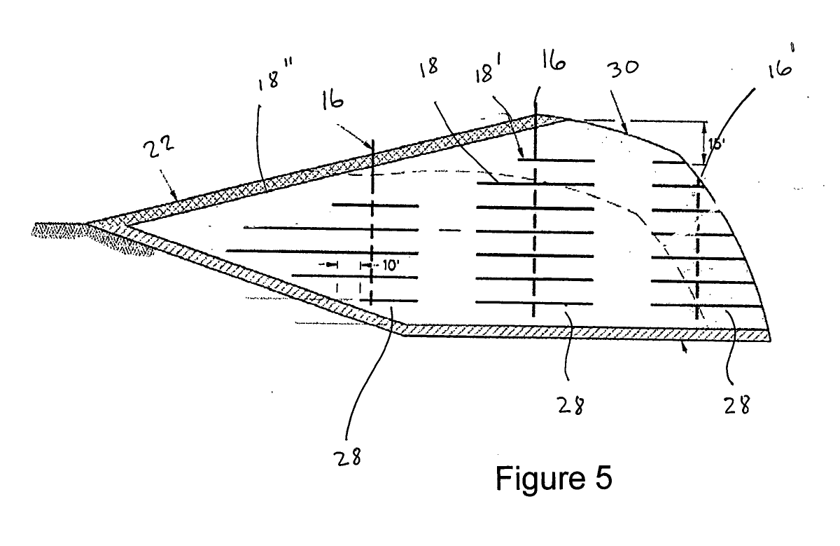

FIG. 5 is a side view of a landfill waste disposal cell embodiment wherein vertical drilled landfill gas extraction well 16′ is located on the slope of the landfill. FIG. 5 demonstrates that a permeable zone 18 consisting of one or more highly permeable material layers 28 may be located along the slope of a landfill. Moreover, FIG. 5 demonstrates that highly permeable material layers 28 do not all need to have the same dimensions. Instead, the shape of highly permeable material layers 28 may vary in order to avoid drawing air into the gas extraction well 16 from shallow areas of the landfill. For example, highly permeable material layers 28, 28′ and 28″ have different horizontal configurations depending upon their proximity to the landfill perimeter.

There are several factors that may be considered when locating a highly porous material layer 28 in a landfill. It is desirable, for example, to avoid drawing air into the landfill gas extraction well via highly permeable material layer 28. Air infiltration can be minimized by insuring that the perimeter of a highly permeable material layer 28 is not near the edge or top of landfill cell 10. In order to minimize air infiltration, the perimeter of a highly permeable material layer 28 should be located a distance of 5 feet or more and preferably 10 feet or more from the landfill cell liner. Moreover, the perimeter of highly permeable material layer 28 should be located at least 5 feet and preferably at least 15 feet or more from the landfill cell perimeter and from the landfill cell cap.

The distance between two highly permeable material layers 28 may also vary significantly depending upon factors such as the location of layer 28 in the landfill, landfill geometry, the type of waste in the landfill, the layer position in the landfill cell and so forth. Generally, highly permeable material layers 28 will be separated by a distance of 10 feet or more and preferably 20 feet or more. Likewise the thickness of a highly permeable material layer 28 can be varied depending upon the same factors as well as upon the selection of the highly permeable material. The highly permeable material layer thickness will generally range from 1 to 18 inches but can range up to 1″ to 5 feet or more.

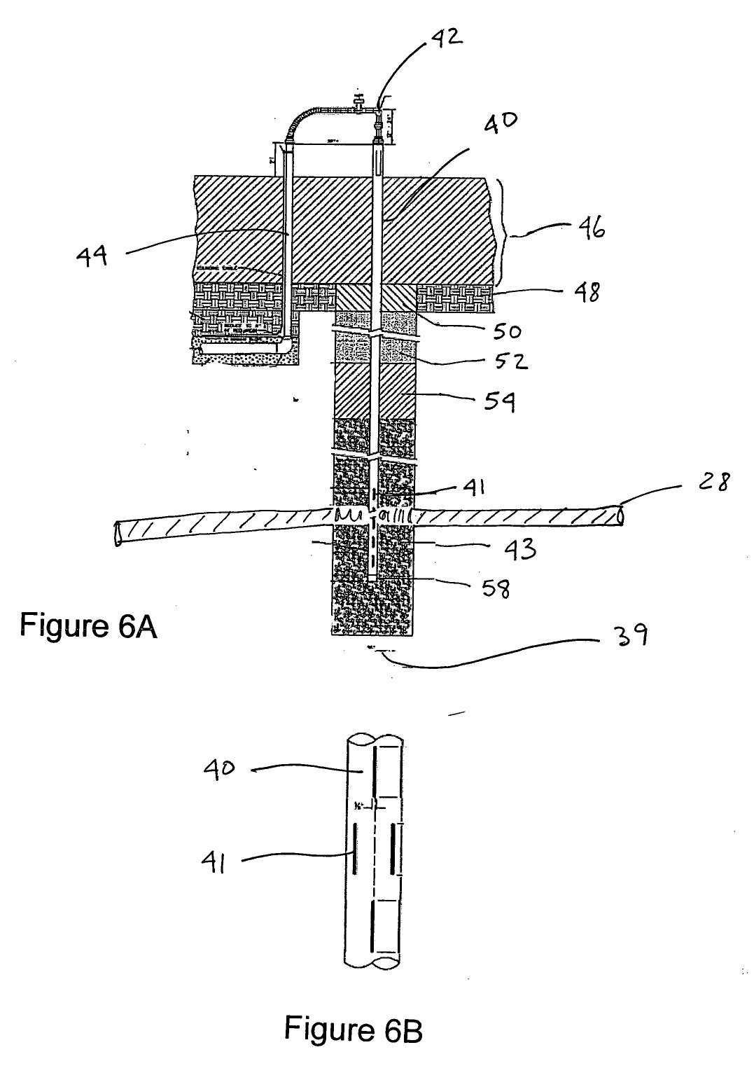

FIGS. 6A and 6B show aspects of a vertical landfill gas extraction well 16. According to the present invention, the vertical drilled landfill gas extraction well 16 may be constructed as landfill lifts are being added to landfill waste disposal cell 10. Alternatively, a plurality of highly permeable material layers 28 may be added to landfill waste disposal cell 10 to form a highly permeable zone and thereafter one or more landfill gas extraction wells can be placed into the landfill waste disposal cell 10 such that the gas extraction well passes through one or more and preferably all of the highly permeable material layers 28 in a permeable zone 18.

A standard landfill gas extraction well is comprised of a bore hole 39 of approximately 3 feet in diameter. A 6 to 10 inch casing 40 including a plurality of perforations 41 is inserted into bore hole 39. Casing 40 includes a first end associated with wellhead 42 and a second end 58 located in bore hole 39. Second end 58 may be capped or it may remain uncapped to allow fluids to drain from casing second end 58. The cylindrical gap between the casing and the bore hole wall is filled with a porous media such as gravel 43. Bore hole 39 is capped with one or more essentially impervious materials. In FIG. 6A, gravel 43 in bore hole 39 is capped with a clay layer 54 over which is located a sand layer 52 on top of which is placed a second clay layer 50. A final cap material layer 46 is placed over bore hole and the remaining landfill materials. Casing 40 is located in bore hole 39 such that perforations 41 in casing 40 are at least associated with highly permeable material layer 28.

The gas extraction well depicted in FIGS. 6A and 6B is merely an example of a gas extraction well that may be located in the landfills of this invention. Any embodiments of landfill gas extraction wells that are known to those of ordinary skill in the art may be employed in the present invention.

The plurality of vertical drilled landfill gas extraction wells 16 will generally be connected via pipe 44 to a piping manifold (not shown) which in turn is connected to a vacuum pump or to a vacuum system in order to draw landfill gases from landfill waste disposal cell 10.

Casing pipe 40 may be perforated along its length, it may include perforations only in the vicinity of each of highly permeable material layers 28 through which it passes, or it may be perforated in any pattern that allows landfill gasses to be drawn into casing 40. It is preferred that at least one vertical landfill gas extraction well 16 is located in the approximate center (as viewed from above) of each permeable zone 28. However, it is within the scope of this invention to include two or more vertical drill landfill gas extraction wells in each permeable zone 28 or to install landfill gas extraction well away from the center of a highly permeable zone 18.

The approximate center of each permeable zone 18 may be identified using GPS or other surveying techniques. In one embodiment, surveying techniques are used to identify the level above grade as well as the approximate corners of each highly permeable material layer 18 as a landfill waste disposal cell is being erected. Once construction of landfill waste disposal cell 10 is complete, the same or similar surveying techniques may be used to identify the approximate centers of each permeable zone 18 for purposes of installing landfill gas extraction well 16.

The methods and landfill cells of this invention are useful for landfills that accept compostable materials that degrade anaerobically or aerobically to form noxious gases such as methane and carbon dioxide. Examples of useful compostable waste materials include, municipal solid waste such paper, wood, food waste and so forth; construction waste including an organic content such as wood fiber, paper and so forth; agricultural waste, and any other types of waste that is organic in nature.

The landfill cells and methods for their construction may be utilized in a variety of landfills. As mentioned above, the methods and landfill cells of this invention are useful in landfills accepting organic waste materials such as municipal solid waste. Additionally, the landfill cells of the methods and landfill cells of this invention may be employed in wet landfills and in landfills that use leachate recovery and/or in bioreactor landfills. The methods of this invention are also useful in landfills that must leave large amounts of cover in place or that have cover material that is revenue generating such as bottom ash. When cover is left in place, gas that is formed during the degradation process moves toward the outside of the landfill as directed by the confining cover layers. The placement of horizontal layers, in between these cover layers allows for more efficient collection by having a wider zone of influence and promoting draining of liquids in the confirming layers. Moreover, the methods and landfills of this invention are useful in dry landfills which are more porous and prone to air infiltration. In dry landfills, because their greater natural porosity, the spacing of gas extraction wells and the location of permeable zones 18 may be enlarged thereby reducing the number of gas extraction wells per acre. Furthermore in landfills with Evapotranspiration Covers, air infiltration is prevented by placing these porous layers deeper in the waste cells so that gas is preferentially collected in areas of the landfills where moisture and gas production is highest. The net effect is more wells per unit area of landfill cover. Finally, the methods of this invention are useful in landfills with large impervious layers of biosolids that prevent gas collection and drainage and in landfills with long or steep exterior slopes which preclude the installation of conventional gas collection wells on the slopes.

There are several advantages that may or may not be achieved by the methods and landfill cells of this invention. The methods and landfill cells of this invention may increase the capacity of gas extraction wells by increase in the void space in the landfill and allowing for a larger zone of gas extraction influence. The landfill embodiments of this invention may allow for drainage in a heterogeneous mass as well as a decrease in air emissions by improving extraction efficiency. Moreover, the landfill embodiments of this invention may allow for geometric preplanning of a gas extraction well field regardless of the nature of the incoming waste material. Finally, the landfill embodiments of this invention may artificially enlarge the gas extraction well surface area.

It is preferred that highly permeable material layers 28 are essentially horizontal. The terms “horizontal” or “essentially horizontal” means a layer is horizontal in nature. The term does not require that the highly permeable material layer be precisely horizontal. A horizontal layer may deviate from horizontal by up to 20 degrees. Moreover, if the term horizontal is not used in the specification and claims in describing a layer such as the highly permeable material layer 28, then this definition of the term “horizontal” does not apply to the layer. In essence, all that is required of the highly permeable material layer 28 is that it be located entirely within a landfill cell, that at least one gas extraction well pass through it and that the gas extraction well are capable of extracting landfill gas from the highly permeable material layer.

The methods and landfill cells of this invention may be useful for assisting in the removal of perched and accumulated liquids in wet landfills. In addition to providing a route for gas to escape the landfill via gas extraction well 16, highly permeable material layers 28 also provide a route for leachate to enter gas extraction well 16. Any liquid entering gas extraction well 16 can exit a hole in the bottom of gas extraction well 16 or it can be removed—in landfills where there is a great amount of water that seeps into gas extraction well 16—by a sump located at the bottom of one or more gas extraction wells.

What is claimed is:

1. A method for constructing a landfill waste disposal cell comprising the steps of:
a. placing a first layer of waste material in a landfill wherein the waste material includes an exposed surface;
b. placing a first highly permeable material layer on top of the first layer of waste material such that the first highly permeable material layer at least partially covers the exposed surface of the first waste material layer;
c. placing a second layer of waste material on the first highly permeable material layer; and
d. installing a gas extraction well including a perforated casing in the landfill cell such that the casing passes through the first horizontal highly permeable material layer.

2. The method of claim 1 wherein perforations in the perforated casing are located in the first highly permeable material layer.

3. The method of claim 1 wherein the second layer of waste material of step c has an exposed surface and wherein a second highly permeable material layer is placed on the exposed surface of the second layer of waste material such that the second highly permeable material layer at least partially covers the exposed surface of the second waste material layer and thereafter, placing a third layer of waste material on top of the second highly permeable material layer.

4. The method of claim 1 wherein a daily cover layer is placed on the exposed surface of the first waste material layer such that the daily cover layer covers essentially all of the exposed surface of the first waste material layer that is not covered by the first highly permeable material layer.

5. The method of claim 1 wherein the highly permeable material layer is comprised of a material selected from a geotextile, a compressible material, a non-compressible material, and any combination thereof.

6. The method of claim 3 wherein the first highly permeable material layer and the second highly permeable material layer are separated by distance of from 10 to about 30 feet.

7. The method of claim 1 wherein a daily cover layer is placed on the exposed surface of the first waste material layer before the first highly permeable material layer is placed on top of the first waste material layer.

8. The method of claim 7 wherein the daily cover layer is non-contiguous in the area of the first highly permeable material layer.

9. The method of claim 1 wherein steps a-c are repeated a plurality of times before performing step d.

10. A method of constructing a permeable zone in a landfill comprising the steps of:
a. placing a first layer of waste material in a landfill wherein the waste material includes an exposed surface;
b. placing a first highly permeable material layer on top of the first layer of waste material such that the first highly permeable material layer at least partially covers the exposed surface of the first waste material layer;
d. placing a second layer of waste material on the first highly permeable material layer wherein the second layer of waste material has an exposed surface;
e. placing a second highly permeable material layer on top of the second layer of waste material such that the second highly permeable material layer at least partially covers the exposed surface of the second waste material layer, the combination of the first highly permeable layer and second highly permeable layer defining a permeable zone; and
f. placing a third layer of waste material on top of the second highly permeable material layer.

11. The method of claim 10 wherein a temperature technique is used to identify the location of the permeable zone.

12. The method of claim 10 wherein a gas extraction well including a perforated casing having a first end and a second end is placed in the permeable zone such that the perforated casing passes through both the first and second highly permeable material layers.

13. The method of claim 10 wherein the first and second highly permeable material layers are both essentially horizontal layers.

14. The method of claim 10 wherein the first and second highly permeable material layers are separated by a distance of from about 5 feet to 30 feet or more.

15. The method of claim 10 wherein the first and second highly permeable material layers each have a thickness of from about 1 inches to about 1.5 feet or more.

16. The method of claim 10 where one of the highly permeable material layers selected from the first highly permeable material layer and the second highly permeable material layer is a geotextile material.

17. The method of claim 10 where one of the highly permeable material layers selected from the first highly permeable material layer and the second highly permeable material layer included a non-compressible permeable material.

18. The method of claim 10 where one of the highly permeable material layers selected from the first highly permeable material layer and the second highly permeable material layer included a compressible permeable material.

19. The method of claim 10 wherein a layer of waste material includes one or more daily cover layers and wherein at least one highly permeable material layer is located between the daily cover layers.

20. The method of claim 10 wherein a daily cover layer is placed on the exposed surface of the first waste material layer before the first highly permeable material layer is placed on top of the first waste material layer

21. A permeable zone located in a landfill comprising:
a plurality of highly permeable layers, each highly permeable layer separated from one another wherein a waste material layer is located between at least two adjacent highly permeable layers; and
a gas extraction well including a casing having a first end located in the landfill a second end located outside of the landfill and a perforated portion located between the casing first end and second end wherein the casing passes through at least one of the highly permeable material layers such that casing perforations are located in the highly permeable material layer.

22. The permeable zone of claim 21 wherein each of the plurality of highly permeable layers are essentially horizontal.

23. The permeable zone of claim 22 wherein each of the plurality of highly permeable material layers are vertically separated from one another.

24. The permeable zone of claim 22 wherein adjacent highly permeable material layers are separated from each other by a distance ranging from about 5 feet to about 40 feet or more.

25. The permeable zone of claim 21 wherein at least one highly permeable material layer is a geotextile layer.

26. The permeable zone of claim 25 wherein the geotextile layer has a thickness of from about 0.25″ to about 6″ or more.

27. The permeable zone of claim 21 wherein the at least one highly permeable material layer is a compressible material layer.

28. The permeable zone of claim 27 wherein the compressible material in the compressible material layer is selected from the group consisting of tire chips, auto fluff, plastic bottles and wood debris.

29. The permeable zone of claim 27 wherein the compressible material has a nominal diameter of from about 2 to about 6 inches and the compressible material layer has a thickness of from about 4 to about 18 inches.

30. The permeable zone of claim 21 wherein at least one of the highly permeable material layers is a non-compressible material layer.

31. The permeable zone of claim 30 where the non-compressible material is selected from the group consisting of sand, gravel, crushed stone, glass cullet, construction debris, and any combination thereof.

32. The permeable zone of claim 30 wherein the non-compressible material has a nominal diameter of from about 0.25″ to 4″ or more and the non-compressible layer has a thickness of from about 2 to about 6 inches.

33. The permeable zone of claim 21 wherein the gas extraction well passes through at least one manmade object selected from the group consisting of an intermediate grade and a temporary haul road.

34. A landfill including at least one permeable zone of claim 21.

35. A landfill including a plurality of permeable zones of claim 21.

36. The landfill of claim 35 wherein the landfill includes a slope and at least one permeable zone associated with the slope such that the second end of the gas well casing protrudes from the slope.
